(19) United States
(12) Patent Application Publication
(10) Pub. No.: US 2026/0169362 A1
(43) Pub. Date: Jun. 18, 2026

(54) PHOTOGRAPHIC DEVICE STRAP AND STABILIZER SYSTEM

(71) Applicant: SHENZHEN LEQI INNOVATION CO., LTD., Shenzhen City (CN)

(72) Inventor: WEI TANG, Shenzhen City (CN)

(73) Assignee: SHENZHEN LEQI INNOVATION CO., LTD., Shenzhen City (CN)

(21) Appl. No.: 19/533,287

(22) Filed: Feb. 8, 2026

Related U.S. Application Data
(63) Continuation of application No. PCT/CN2024/097455, filed on Jun. 5, 2024.

(30) Foreign Application Priority Data
Aug. 8, 2023 (CN) 202322129904.1

(51) Int. Cl. G03B 17/56; A45F 5/00

(52) U.S. Cl. CPC G03B 17/561; A45F 5/1533; A45F 2005/006

(57) ABSTRACT

A photographic device strap comprises a strap assembly, wherein one end of the strap assembly is provided with a first external-connection assembly and the other end is provided with a second external-connection assembly; the first external-connection assembly comprises at least one first locking component, a connection seat and a first connection sub-assembly detachably connected to the connection seat; and each of the first locking component is mounted on the connection seat. In the photographic device strap, the first external-connection assembly and the second external-connection assembly connect to photographic device. The first locking component locks the connection seat onto photographic device. The first and second external-connection assemblies enhance the universal applicability of the photographic device strap. The first connection sub-assembly facilitates the detachable connection of the strap assembly to the connection seat, making it easy to store and disassemble.

### CROSS-REFERENCE TO RELATED APPLICATIONS

The present application is a continuation of PCT Application No. PCT/CN2024/097455 filed on Jun. 5, 2024, which claims priority to Chinese Utility Model Application No. 202322129904.1, entitled “PHOTOGRAPHIC DEVICE STRAP AND STABILIZER SYSTEM”, filed to the China National Intellectual Property Administration on Aug. 8, 2023, the entire contents of which are incorporated herein by reference.

### TECHNICAL FIELD

The present invention relates to the field of photography, and in particular, to a photographic device strap and a stabilizer system.

### BACKGROUND

Carrying straps are commonly used for transporting photographic devices such as tripods, cameras and backpacks. Existing straps are usually provided with quick-release buckles at both ends. However, they are not designed to match stabilizers. When using a stabilizer for shooting with a camera, the stabilizer is relatively heavy, creating an urgent need for a photographic/video strap compatible with stabilizers.

### SUMMARY

A primary objective of the present invention is to provide a photographic device strap that solves the technical problem of a photographic device strap for use in conjunction with stabilizer shooting.

To achieve the above objective, a photographic device strap according to the present invention comprises a strap assembly, wherein one end of the strap assembly is provided with a first external-connection assembly and the other end is provided with a second external-connection assembly;
the first external-connection assembly comprises at least one first locking component, a connection seat and a first connection sub-assembly detachably connected to the connection seat; and each of the first locking component is mounted on the connection seat.

In one embodiment, the connection seat is provided with at least one mounting hole penetrating vertically; the mounting hole each accommodates one of the first locking component; and the first locking component is a screw, with a threaded rod passing through the mounting hole and extending beyond a bottom surface of the connection seat.

In one embodiment, the number of the first locking components is at least two, including a ¼-inch screw and another and an M4 screw.

In one embodiment, the connection seat further comprises a positioning assembly that includes a positioning component and an elastic component; one end of the positioning component extends beyond the bottom surface of the connection seat, and the other end is elastically connected to the connection seat via the elastic component.

In one embodiment, the first connection sub-assembly is a QD (Quick-Detach) buckle, and the connection seat is correspondingly provided with at least one QD hole, including a QD hole extending in the same direction as the mounting hole.

In one embodiment, the second external-connection assembly has the same structure as the first external-connection assembly.

In one embodiment, the second external-connection assembly comprises a second locking component, a base and a second connection sub-assembly detachably connected to the base; the second locking component is mounted on the base, and the base is configured to be connected to a bottom end of a stabilizer battery handle through the second locking component.

In one embodiment, the second locking component is a screw, with a threaded rod protrudes beyond an upper surface of the base; a lower surface of the base is recessed with at least one threaded hole, or two or more threaded holes that are identical in size, different in size, or in any combination thereof.

In one embodiment, the second connection sub-assembly is a QD (Quick-Detach) buckle;
the base is correspondingly provided with at least one QD hole, including a QD hole located on a side surface of the base; or the base is correspondingly provided with at least two QD holes, including two QD holes spaced apart on the side surface of the base;
or/and, a toothed-plate connection interface is further provided on the side surface of the base.

In one embodiment, the strap assembly comprises a strap and at least one adjustment buckle for adjusting a length of the strap, and the adjustment buckle is provided with four spaced elongate through-slots.

In one embodiment, the strap assembly further comprises at least one rectangular ring, a side end of which is recessed with at least one QD (Quick-Detach) hole for detachable coupling to a QD buckle.

In one embodiment, the strap assembly comprises two adjustment buckles and one rectangular ring; the strap has a first strap end and a second strap end; the strap passes through two middle elongate through-slots of an adjustment buckle, and the first strap end passes through two outer elongate through-slots of the same adjustment buckle, forming a first half-loop portion; one side of the rectangular ring is connected to the first half-loop portion; the strap assembly further comprises a connection strap having a third strap end and a fourth strap end, the other side of the rectangular ring is connected to the third strap end, the fourth strap end is connected to the first connection sub-assembly;
the strap further passes through two middle elongate through-slots of the other adjustment buckle, and the second strap end passes through two outer elongate through-slots of said other adjustment buckle, forming a second half-loop portion, and the second external-connection assembly is mounted on the second half-loop portion.

To achieve the above objective, a stabilizer system according to the present invention comprises a stabilizer bracket and the photographic device strap, wherein the stabilizer bracket comprises a stabilizer battery handle, the second external-connection assembly is connected to a bottom end of the stabilizer battery handle, and the first connection sub-assembly is arranged on the stabilizer bracket or on a tilting handle mounted on the stabilizer bracket.

To achieve the above objective, a photographic device strap according to the present invention comprises:
a strap assembly,
a first external-connection assembly, provided at one end of the strap assembly; and
a second external-connection assembly, provided at the other end of the strap assembly;
wherein the first external-connection assembly comprises a first locking component, a connection seat and a first connection sub-assembly, the connection seat is configured for connecting to photographic device by the first locking component;
the second external-connection assembly comprises a second locking component, a base and a second connection sub-assembly, the base is configured for connecting to a stabilizer by the second locking component;
the first connection sub-assembly is detachably connected to the connection seat, and/or the second connection sub-assembly is detachably connected to the base.

In one embodiment, the first connection sub-assembly is a quick-release structure compatible with the connection seat; and/or the second connection sub-assembly is a quick-release structure compatible with the base.

In one embodiment, the first connection sub-assembly is a QD (Quick-Detach) buckle, the connection seat is correspondingly provided with at least one QD hole; the second connection sub-assembly is a QD buckle, and the base is correspondingly provided with at least one QD hole.

In one embodiment, the strap assembly comprises a strap and at least one adjustment buckle, the adjustment buckle is provided with spaced elongate through-slots, and the strap passes through the elongate through-slots for adjusting a length of the strap.

In one embodiment, the strap assembly further comprises at least one rectangular ring, one of the first connection sub-assembly and the second connection sub-assembly is connected to a QD hole on photographic device, and the other can be inserted into a QD hole on the rectangular ring to form a carrying loop.

In one embodiment, both ends of the strap are equipped with QD buckles, one of which is connected to a QD hole of the connection seat and the other is connected to a QD hole on the base.

In one embodiment, the strap assembly further comprises a connecting strap, the strap assembly comprises two adjustment buckles and one rectangular ring, the strap passes through one adjustment buckle to form a first half-loop portion, the strap passes through the other adjustment buckle to form a second half-loop portion; one side of the rectangular ring is connected to the first half-loop portion, and the other side of the rectangular ring is connected to the connecting strap.

In the photographic device strap according to the present invention, the first external-connection assembly and the second external-connection assembly connect to photographic device such as stabilizers and tripods. The first locking component locks the connection seat onto photographic device like stabilizers and tripods. The first and second external-connection assemblies enhance the universal applicability of the photographic device strap. The first connection sub-assembly facilitates the detachable connection of the strap assembly to the connection seat, making it easy to store and disassemble. The structure is simple and operation is convenient. After the first connection sub-assembly is separated from the connection seat, the strap assembly can still be connected to photographic device compatible with the first connection sub-assembly.

### BRIEF DESCRIPTION OF THE DRAWINGS

In order to explain the embodiments of the present invention or the technical solutions in the prior art more clearly, the following will briefly introduce the drawings required for describing the embodiments or the prior art. Obviously, the drawings in the following description are only some embodiments of the present invention. For those of ordinary skill in the art, other drawings can also be obtained based on the structures shown in these drawings without creative effort.

FIG. 1 is a photograph of a stabilizer system according to the present invention.

FIG. 2 is a schematic structural view of the stabilizer system according to the present invention.

FIG. 3 is a schematic structural view of the stabilizer system according to the present invention from another angle.

FIG. 4 is a schematic structural view of a photographic device strap according to the present invention from one angle.

FIG. 5 is a schematic structural view of a strap assembly according to the present invention.

FIG. 6 is a partial exploded view of the strap assembly according to the present invention.

FIG. 7 is a schematic structural view of the first and second external-connection assemblies of the photographic device strap according to the present invention.

FIG. 8 is a schematic structural view of the first and second external-connection assemblies of the photographic device strap according to the present invention from another angle.

### REFERENCE NUMERALS

first external-connection assembly 1;
first locking component 11;
connection seat 12;
mounting hole 121;
first connection sub-assembly 13;
positioning component 14;
QD hole 2;
threaded hole 21;
second external-connection assembly 3;
second locking component 31;
base 32;
gear disc connection interface 321;
semi-recessed groove 322;
second connecting component 33;
strap 4;
first strap end 41;
second strap end 42;
first half-loop portion 43;
second half-loop portion 44;
connecting strap 5;
third strap end 51;
fourth strap end 52;
adjustment buckle 6;
elongate through-slot 61;
rectangular ring 7;
stabilizer battery handle 8;
tilting handle 9.

The realization of the objectives, functional features, and advantages of the present invention will be further explained in conjunction with the embodiments and with reference to the accompanying drawings.

### DESCRIPTION OF THE EMBODIMENTS

Hereinafter, the technical solutions in the embodiments of the present invention will be described clearly and completely with reference to the accompanying drawings. It is obvious that the described embodiments are only part of the embodiments of the present invention, not all of them. Based on the embodiments of the present invention, all other embodiments obtained by those of ordinary skill in the art without making creative efforts fall within the protection scope of the present invention.

It should be noted that, if an embodiment of the present invention involves directional indications (such as up, down, left, right, front, back, etc.), these directional indications are only used to explain the relative positional relationship and movement between components under a specific posture (as shown in the drawings). When the specific posture changes, the directional indication changes accordingly.

In addition, if an embodiment of the present invention involves descriptions such as “first”, “second”, etc., these descriptions are only for descriptive purposes, and should not be understood as indicating or implying relative importance or implicitly indicating the number of indicated technical features. Thus, features defined with “first” or “second” may explicitly or implicitly include at least one such feature. In addition, the meaning of “and/or” appearing in the text includes three parallel schemes. Taking “A and/or B” as an example, it includes scheme A, scheme B, and a scheme where A and B are satisfied at the same time. The technical solutions of the various embodiments may be combined with each other, but they must be based on what those of ordinary skill in the art can achieve. When the combination of technical solutions is contradictory or impossible to achieve, it should be considered that such a combination does not exist and does not fall within the protection scope required by the present invention.

The present invention proposes a photographic device strap, applied to photographic device. Photographic device is a general term for cameras, lenses and their related accessories, various equipment and items related to photographic activities. This includes consumables like film, and items commonly handled by photographic device dealers such as photography vests and camera bags, all of which fall within the category of photographic device, also known as photographic accessories. The scope of photographic device is very broad. In addition to commonly known cameras, it mainly includes various zoom lenses, prime lenses, flash units, filters for various purposes, camera bags, camera tripods, studio flash units, soft boxes, various light stands, reflectors, reflective umbrellas, location lights, video lights, quartz lights, lens caps, lens hoods, tripods, adapter plates, expansion accessory plates, quick-release components, brackets, monopods, stabilizers, camera cleaning tools, shutter release cables, etc. It also includes accessories for the aforementioned equipment. Traditional photographic device also includes enlargers, safelights, print dryers, temperature-controlled trays, timers, etc., used in darkrooms. Color processors and printers also belong to photographic device. Digital cameras have already integrated photography and videography, and hence they are also referred to more broadly as imaging equipment, encompassing both photography and videography systems.

To facilitate carrying photographic/videographic equipment or assisting in shooting with such equipment, photographic device straps are often used. Existing photographic device straps employ QD (Quick-Detach) buckles at both ends, which can only adapt to photographic device with QD holes. Existing stabilizers have a gimbal on an upper part for mounting a camera, a stabilizer battery handle in the middle, and a threaded hole at a lower end of the battery handle for mounting a tripod or other brackets. They cannot adapt to straps with QD buckles, nor can they adapt to other current types of straps. Therefore, the present invention proposes a photographic device strap that can adapt to photographic device with threaded holes, such as stabilizers, tripods, cages (camera protective frames, monitor protective frames, which can be semi-enclosed or fully enclosed), etc. Matching first and second external-connection assemblies can be set according to the specifications of the threaded holes, as detailed below.

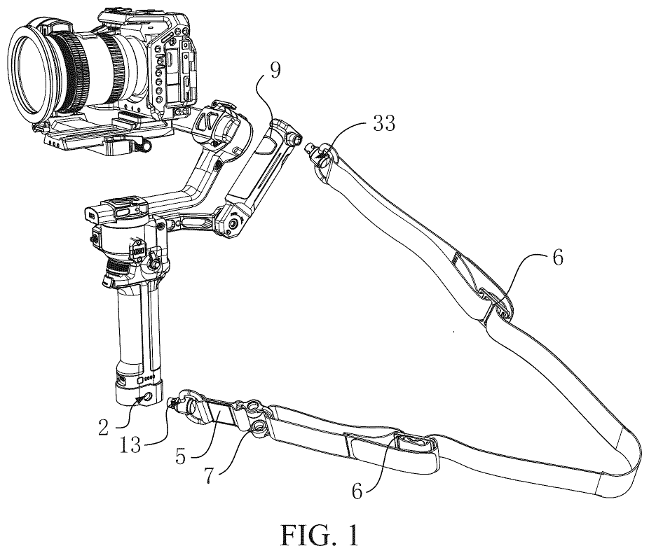

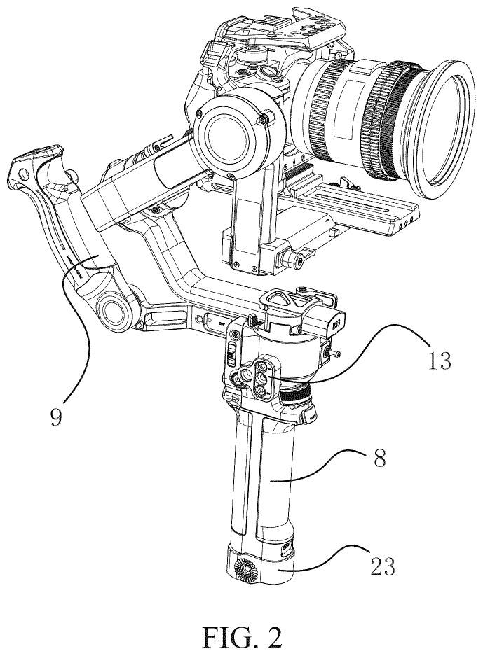

As shown in FIGS. 1 to 4, the photographic device strap comprises a strap assembly. A first external-connection assembly 1 is provided at one end of the strap assembly, and a second external-connection assembly 3 is provided at the other end. The first external-connection assembly 1 comprises at least one first locking component 11, a connection seat 12, and a first connection sub-assembly 13 detachably connected to the connection seat 12. Each of the first locking component 11 is mounted on the connection seat 12.

In this embodiment, the connection seat 12 is provided with at least one mounting hole 121 penetrating vertically. One mounting hole 121 accommodates one of the first locking component 11. The first locking component 11 is a screw. A threaded rod of the first locking component 11 passes through the mounting hole 121 and extends beyond a bottom surface of the connection seat 12. The number of mounting holes 121 corresponds to the number of first locking components 11. The mounting holes 121 can be one, two, three, four, etc. When three mounting holes 121 are provided, the screws may be of identical or different sizes, or any combination. For example, two screws may be ¼-inch screws, and the third screw may be an M4 screw. Alternatively, two screws may be M4 screws, and the third screw may be a ¼-inch screw. The specifications of the first locking components 11 are set according to usage requirements.

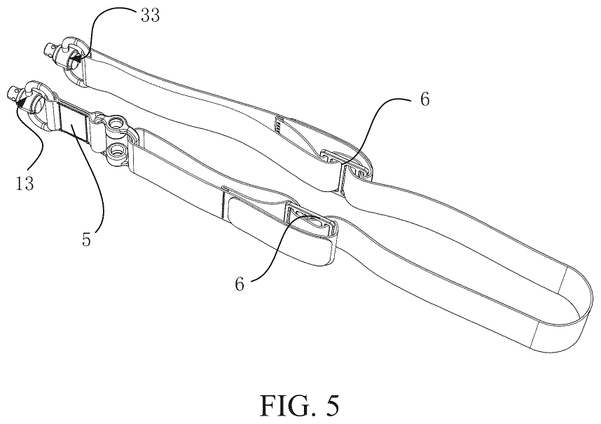

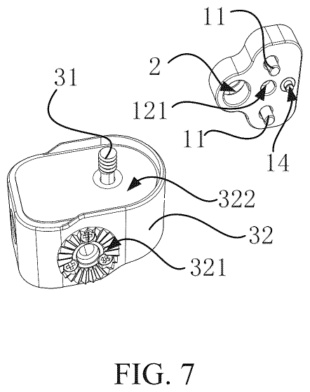

As shown in FIGS. 5 and 7, the first connection sub-assembly 13 can be a QD (Quick-Detach) buckle. Of course, it can also be other quick-release structures compatible with the connection seat 12, such as clips, snap buttons, slide buckles, etc., which are not limited here.

The photographic device strap connects to photographic device such as stabilizers and tripods through the first external-connection assembly 1 and the second external-connection assembly 3. The first locking component 11 locks the connection seat 12 onto photographic device such as stabilizers and tripods. The first external-connection assembly 1 and the second external-connection assembly 3 enhance the universal applicability of the photographic device strap. The first connection sub-assembly 13 facilitates the detachable connection of the strap assembly to the connection seat 12, making it easy to store and disassemble. The structure is simple and operation is convenient. After the first connection sub-assembly 13 is separated from the connection seat 12, the strap assembly can still be connected to photographic device compatible with the first connection sub-assembly 13.

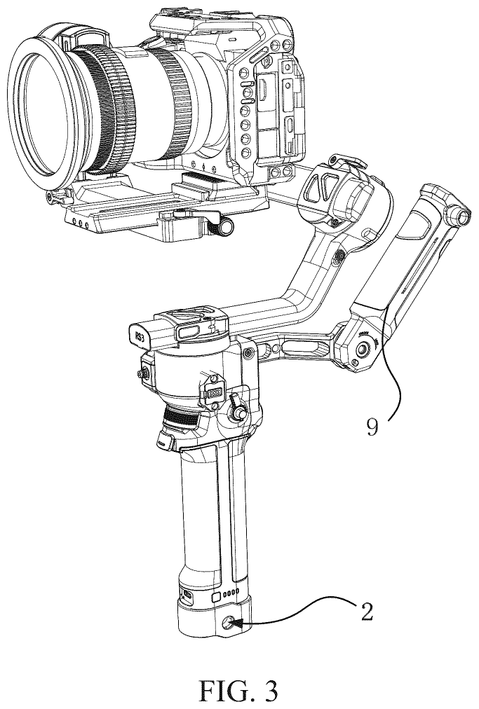

In some embodiments, as shown in FIGS. 5 and 3, the number of first locking components 11 is at least two. One of the first locking components 11 is a ¼-inch screw, and another of the first locking components 11 is an M4 screw. The screws can also be of other specifications, such as M1.3 to M8, etc.

In some embodiments, to prevent the connection seat 12 from rotating relative to the photographic device it is connected to, the connection seat 12 is further provided with a positioning assembly 14. The positioning assembly 14 comprises a positioning component and an elastic component. One end of the positioning component extends beyond the bottom surface of the connection seat 12, and the other end is elastically connected to the connection seat 12 through the elastic component. This also enhances the connection stability between the connection seat 12 and the photographic device. The positioning component can be a cylindrical pin with a rounded head for easy positioning.

In some embodiments, the first connection sub-assembly 13 is a QD (Quick-Detach) buckle, and the connection seat 12 is correspondingly provided with at least one QD hole 2. One of the QD holes 2 is aligned with an extending direction of the mounting hole 121. An entrance of the QD hole 2 is located on a side of the connection seat 12 opposite to a surface connected to the photographic device. The number of QD holes 2 is not limited and may include other QD holes 2 aligned or not aligned with the extending direction of the mounting hole 121, such as those located on the side of the connection seat 12, etc. The connection seat 12 can be plate-shaped. The connection seat 12 can be provided with three mounting holes 121 arranged side by side and spaced apart. The QD hole 2 is provided on a protruding portion in the middle area of the side of the connection seat 12. The structure is simple and occupies little space. The shape of the connection seat 12 can match the shape of the connection portion of the photographic device, such as being made circular to match a recess at the connection portion, etc.

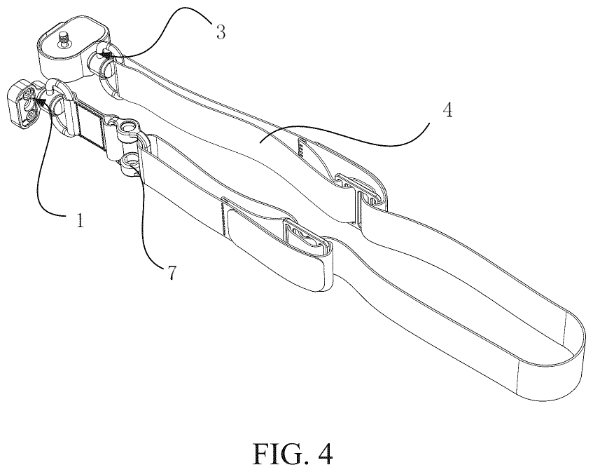

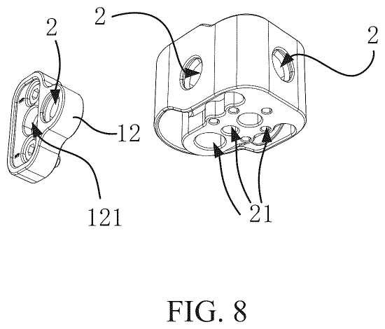

In some embodiments, the second external-connection assembly 3 has the same structure as the first external-connection assembly 1. Of course, as shown in FIGS. 4, 7, and 8, the second external-connection assembly 3 can also have a different structure from the first external-connection assembly 1. For example, the second external-connection assembly 3 comprises a second locking component 31, a base 32, and a second connection sub-assembly 33 detachably connected to the base 32. The second locking component 31 is arranged on the base 32. The base 32 is used for connecting to a bottom end of a stabilizer battery handle 8 through the second locking component 31.

Herein, the second locking component 31 is a screw. A threaded rod of the second locking component 31 extends beyond the upper surface of the base 32. A lower surface of the base 32 is recessed with at least one, two, or more threaded holes 21 of the same, different, or any combination of specifications for connecting external photographic accessories, such as tripods, etc. The connection seat 12 and the base 32 can also be provided with other external interfaces, such as slide rail interfaces, dovetail groove interfaces, Arri locating pins, toothed-plate connection interfaces 321, etc.

In some embodiments, for convenient and quick disassembly, the second connection sub-assembly 33 is a QD buckle. The base 32 is correspondingly provided with at least one QD hole 2. One of the QD holes 2 is located on a side surface of the base 32. Alternatively, the base 32 is correspondingly provided with at least two QD holes 2, and two of the QD holes 2 are spaced apart on a side surface of the base 32. A toothed-plate connection interface 321 is further provided on the side surface of the base 32.

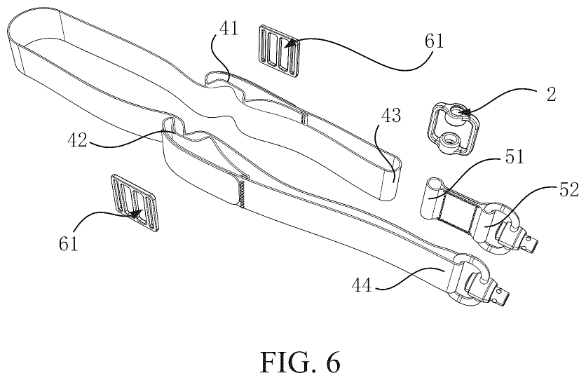

In some embodiments, as shown in FIGS. 5 and 6, the strap assembly comprises a strap 4. The strap assembly further comprises at least one adjustment buckle 6 for adjusting a length of the strap 4. The adjustment buckle 6 is provided with four spaced elongate through-slots 61, and the strap 4 can pass through the elongate through-slots 61.

Furthermore, the strap assembly further comprises at least one rectangular ring 7. At least one QD hole 2 is recessed on a side end of the rectangular ring 7 for detachably connecting to a QD buckle. Therefore, the first connection sub-assembly 13 detached from the connection seat 12 and the second connection sub-assembly 33 detached from the base 32 can be utilized. One of them can be connected to a QD hole 2 on a camera, and the other can be inserted into the QD hole 2 on the rectangular ring 7 to form a carrying loop. This allows for carrying photographic/videographic device with QD holes 2, such as a camera.

In some embodiments, the strap assembly comprises two adjustment buckles 6 and one rectangular ring 7. The strap 4 comprises a first strap end 41 and a second strap end 42. The strap 4 passes through the middle two elongate through-slots 61 of one adjustment buckle 6, and the first strap end 41 passes through the two elongate through-slots 61 on both sides of the same adjustment buckle 6, thereby forming a first half-loop portion 43 with the strap 4. One side of the rectangular ring 7 is connected to the first half-loop portion 43. The strap assembly further comprises a connecting strap 5, which includes a third strap end 51 and a fourth strap end 52. The other side of the rectangular ring 7 is connected to the third strap end 51, and the fourth strap end 52 is connected to the first connection sub-assembly 13. The strap 4 also passes through the middle two elongate through-slots 61 of the other adjustment buckle 6. The second strap end 42 passes through the two elongate through-slots 61 on both sides of that adjustment buckle 6, thereby forming a second half-loop portion 44 with the strap 4. The second external-connection assembly 3 is m on the mounted onto the half-loop portion 44.

Herein, after assembly, a portion of the strap 4 between the first strap end 41 and the second strap end 42 sequentially passes through the middle two elongate through-slots 61 of the two adjustment buckles 6. The first strap end 41 and the second strap end 42 extend from the same side of the two adjustment buckles 6. The first strap end 41 then folds back toward the outside of the strap 4 and passes through the elongate through-slots 61 on both sides of the adjacent adjustment buckle 6. The first strap end 41 loops around the middle two elongate through-slots 61 of that buckle, and the free end of the first strap end 41, after passing through the adjustment buckle 6, is sewn onto the main body of the strap 4. Thus, one adjustment buckle 6 is fixed to the first strap end 41. Pulling the strap 4 causes it to pass through the middle two elongate through-slots 61 of the adjustment buckle 6, which can increase or decrease the size of the annular area formed by the first half-loop portion 43. That is, reducing the overlap of the strap 4 in the first half-loop portion 43 lengthens the strap 4, while simultaneously moving the two adjustment buckles 6 farther apart on the strap 4. Conversely, increasing the overlap of the strap 4 in the first half-loop portion 43 shortens the strap 4, while simultaneously moving the two adjustment buckles 6 closer together on the strap 4.

Similarly, the second strap end 42 folds back toward the outside of the strap and passes through the elongate through-slots 61 on both sides of the adjacent adjustment buckle 6. The second strap end 42 loops around the middle two elongate through-slots 61 of that buckle, and the free end of the second strap end 42, after passing through the adjustment buckle 6, is sewn onto the main body of the strap. Thus, the other adjustment buckle 6 is fixed to the second strap end 42. Pulling the strap causes the strap 4 to pass through the middle two elongate through-slots 61 of the adjustment buckle 6, which can increase or decrease the size of the annular area formed by the second half-loop portion 44. That is, reducing the overlap of the strap 4 in the second half-loop portion 44 lengthens the strap 4, while simultaneously moving the two adjustment buckles 6 farther apart on the strap 4. Conversely, increasing the overlap of the strap 4 in the second half-loop portion 44 shortens the strap 4, while simultaneously moving the two adjustment buckles 6 closer together on the strap 4. Therefore, the two adjustment buckles 6 can be adjusted simultaneously or individually.

In some embodiments, the strap assembly comprises two adjustment buckles 6. The strap 4 comprises a first strap end 41 and a second strap end 42. The strap 4 passes through the middle two elongate through-slots 61 of one adjustment buckle 6. The first strap end 41 passes through the two elongate through-slots 61 on both sides of that adjustment buckle 6, thereby forming a first half-loop portion 43 with the strap. The first half-loop portion 43 is connected to the first connection sub-assembly 13. The strap 4 also passes through the middle two elongate through-slots 61 of the other adjustment buckle 6. The second strap end 42 passes through the two elongate through-slots 61 on both sides of that adjustment buckle 6, thereby forming a second half-loop portion 44 with the strap 4. The second connection sub-assembly 33 is installed on the second half-loop portion 44.

In summary, both ends of the strap 4 are equipped with QD buckles. These two QD buckles can be connected to connection seats 12 respectively. The connection seat 12 is provided with mounting holes 121 arranged side by side and spaced apart, and one QD hole 2. The strap 4 can be mounted on a camera cage via the two connection seats 12. Screws on the connection seat 12 pass through the mounting holes 121 and screw into the threaded holes 21 on the side frame of the camera cage. The positioning component abuts against the cage or extends into a positioning hole on the cage.

Alternatively, both ends of the strap are equipped with QD buckles. One QD buckle connects to the QD hole 2 of a connection seat 12, and the other QD buckle connects to a QD hole 2 on a base 32. A screw passes through the base 32 and screws into the threaded hole 21 at a bottom end of the stabilizer battery handle 8, thereby fixing the base 32 to the stabilizer battery handle 8. A screw on the connection seat 12 passes through the connection seat 12 and connects to a threaded hole 21 on the upper part or side of the stabilizer. This allows the strap to be worn, carrying the stabilizer system. Of course, the connection seat 12 can also be connected to a tilting handle 9, or the QD buckle can be detached from the connection seat 12 and directly connected to a QD hole 2 on the tilting handle 9. To achieve a more stable connection between the base 32 and the stabilizer battery handle 8, as shown in FIG. 7, the upper surface edge of the base 32 is provided with an upwardly extending peripheral wall, forming a semi-recessed groove 322. This allows the stabilizer battery handle 8 to slide in for installation from the side opening of the semi-recessed groove 322.

Therefore, when both ends of the strap are equipped with QD buckles, these two QD buckles can also be directly connected to other photographic accessories that have QD holes 2, without the connection seat 12 and the base 32.

The present invention further proposes a stabilizer system. The stabilizer system comprises a stabilizer bracket and the photographic device strap as described above. The stabilizer bracket includes a stabilizer battery handle 8. The second external-connection assembly 3 is connected to the bottom end of the stabilizer battery handle 8. The first connection sub-assembly 13 is arranged on the stabilizer bracket or on a tilting handle 9 mounted on the stabilizer bracket.

The aforementioned descriptions are merely optional embodiments of the present invention and are not intended to limit the patent scope of the present invention. Under the inventive concept of the present invention, any equivalent structural transformations made using the contents of the specification and drawings of the present invention, or any direct/indirect application in other related technical fields, shall be included within the patent protection scope of the present invention.

What is claimed is:

1. A photographic device strap, comprising a strap assembly, wherein one end of the strap assembly is provided with a first external-connection assembly and the other end is provided with a second external-connection assembly;
the first external-connection assembly comprises at least one first locking component, a connection seat and a first connection sub-assembly detachably connected to the connection seat; and each of the first locking component is mounted on the connection seat.

2. The photographic device strap according to claim 1, wherein the connection seat is provided with at least one mounting hole penetrating vertically; the mounting hole each accommodates one of the first locking component; and the first locking component is a screw, with a threaded rod passing through the mounting hole and extending beyond a bottom surface of the connection seat.

3. The photographic device strap according to claim 2, wherein the number of the first locking components is at least two, including a ¼-inch screw and another and an M4 screw.

4. The photographic device strap according to claim 2, wherein the connection seat further comprises a positioning assembly that includes a positioning component and an elastic component; one end of the positioning component extends beyond the bottom surface of the connection seat, and the other end is elastically connected to the connection seat via the elastic component.

5. The photographic device strap according to claim 2, wherein the first connection sub-assembly is a QD (Quick-Detach) buckle, and the connection seat is correspondingly provided with at least one QD hole, including a QD hole extending in the same direction as the mounting hole.

6. The photographic device strap according to claim 1, wherein the second external-connection assembly has the same structure as the first external-connection assembly.

7. The photographic device strap according to claim 1, wherein the second external-connection assembly comprises a second locking component, a base and a second connection sub-assembly detachably connected to the base; the second locking component is mounted on the base, and the base is configured to be connected to a bottom end of a stabilizer battery handle through the second locking component.

8. The photographic device strap according to claim 1, wherein the second locking component is a screw, with a threaded rod protrudes beyond an upper surface of the base; a lower surface of the base is recessed with at least one threaded hole, or two or more threaded holes that are identical in size, different in size, or in any combination thereof.

9. The photographic device strap according to claim 7, wherein the second connection sub-assembly is a QD (Quick-Detach) buckle;
the base is correspondingly provided with at least one QD hole, including a QD hole located on a side surface of the base; or the base is correspondingly provided with at least two QD holes, including two QD holes spaced apart on the side surface of the base;
or/and, a toothed-plate connection interface is further provided on the side surface of the base.

10. The photographic device strap according to claim 1, wherein the strap assembly comprises a strap and at least one adjustment buckle for adjusting a length of the strap, and the adjustment buckle is provided with four spaced elongate through-slots.

11. The photographic device strap according to claim 1, wherein the strap assembly further comprises at least one rectangular ring, a side end of which is recessed with at least one QD (Quick-Detach) hole for detachable coupling to a QD buckle.

12. The photographic device strap according to claim 11, wherein the strap assembly comprises two adjustment buckles and one rectangular ring; the strap has a first strap end and a second strap end; the strap passes through two middle elongate through-slots of an adjustment buckle, and the first strap end passes through two outer elongate through-slots of the same adjustment buckle, forming a first half-loop portion; one side of the rectangular ring is connected to the first half-loop portion; the strap assembly further comprises a connection strap having a third strap end and a fourth strap end, the other side of the rectangular ring is connected to the third strap end, the fourth strap end is connected to the first connection sub-assembly;
the strap further passes through two middle elongate through-slots of the other adjustment buckle, and the second strap end passes through two outer elongate through-slots of said other adjustment buckle, forming a second half-loop portion, and the second external-connection assembly is mounted on the second half-loop portion.

13. A stabilizer system, comprising a stabilizer bracket and the photographic device strap according to claim 1, wherein the stabilizer bracket comprises a stabilizer battery handle, the second external-connection assembly is connected to a bottom end of the stabilizer battery handle, and the first connection sub-assembly is arranged on the stabilizer bracket or on a tilting handle mounted on the stabilizer bracket.

14. A photographic device strap, comprising:
a strap assembly;
a first external-connection assembly, provided at one end of the strap assembly; and
a second external-connection assembly, provided at the other end of the strap assembly;
wherein the first external-connection assembly comprises a first locking component, a connection seat and a first connection sub-assembly, the connection seat is configured for connecting to photographic device by the first locking component;
the second external-connection assembly comprises a second locking component, a base and a second connection sub-assembly, the base is configured for connecting to a stabilizer by the second locking component;
the first connection sub-assembly is detachably connected to the connection seat, and/or the second connection sub-assembly is detachably connected to the base.

15. The photographic device strap according to claim 14, wherein the first connection sub-assembly is a quick-release structure compatible with the connection seat; and/or the second connection sub-assembly is a quick-release structure compatible with the base.

16. The photographic device strap according to claim 15, wherein the first connection sub-assembly is a QD (Quick-Detach) buckle, the connection seat is correspondingly provided with at least one QD hole; the second connection sub-assembly is a QD buckle, and the base is correspondingly provided with at least one QD hole.

17. The photographic device strap according to claim 14, wherein the strap assembly comprises a strap and at least one adjustment buckle, the adjustment buckle is provided with spaced elongate through-slots, and the strap passes through the elongate through-slots for adjusting a length of the strap.

18. The photographic device strap according to claim 17, wherein the strap assembly further comprises at least one rectangular ring, one of the first connection sub-assembly and the second connection sub-assembly is connected to a QD hole on photographic device, and the other can be inserted into a QD hole on the rectangular ring to form a carrying loop.

19. The photographic device strap according to claim 17, wherein both ends of the strap are equipped with QD buckles, one of which is connected to a QD hole of the connection seat and the other is connected to a QD hole on the base.

20. The photographic device strap according to claim 17, wherein the strap assembly further comprises a connecting strap, the strap assembly comprises two adjustment buckles and one rectangular ring, the strap passes through one adjustment buckle to form a first half-loop portion, the strap passes through the other adjustment buckle to form a second half-loop portion; one side of the rectangular ring is connected to the first half-loop portion, and the other side of the rectangular ring is connected to the connecting strap.
